(19) United States
(12) Patent Application Publication
(10) Pub. No.: US 2026/0086237 A1
(43) Pub. Date: Mar. 26, 2026

(54) HYBRID THREE-DIMENSIONAL SENSING SYSTEM AND METHOD

(71) Applicant: HIMAX TECHNOLOGIES LIMITED, Tainan City (TW)

(72) Inventors: Min-Chian WU, Tainan City (TW); Cheng Che TSAI, Tainan City (TW); Ching-Wen WANG, Tainan City (TW)

(21) Appl. No.: 18/895,352

(22) Filed: Sep. 24, 2024

(51) Int. Cl. G01S 17/894; G01S 7/48

(52) U.S. Cl. CPC G01S 17/894; G01S 7/4804; G01S 7/4808

(57) ABSTRACT

A hybrid 3D sensing system including a time-of-flight (ToF) projector, a structured light (SL) projector, a ToF sensor, a ToF processor, and a SL processor. The ToF projector projects a modulated light on an object in a ToF mode. The SL projector projects a structured light on the object in a SL mode. The ToF sensor receives reflections from the object and correspondingly generates video data. The ToF processor receives the video data and generates ToF depth information according to the video data in the ToF mode. The SL processor receives a 2D image from the ToF processor and generates SL depth information according to the 2D image in the SL mode.

### BACKGROUND

### Field of Invention

The present disclosure relates to three-dimensional (3D) sensing. More particularly, the present disclosure relates to a hybrid 3D sensing system and a hybrid 3D sensing method.

### Description of Related Art

Three-dimensional (3D) scanning or sensing is one of disciplines adaptable to computer vision to analyze a real-world object or environment to collect data on shape and appearance of the object to be analyzed. The 3D scanning or sensing can be based on many different technologies, each with its own advantages and limitations.

Structured-light scanning is a 3D scanning scheme that projects a pattern of light onto a scene. The deformation of the pattern is captured by a camera, and then processed, for example, by triangulation, to reconstruct a three-dimensional or depth map of the objects in the scene. Although the structured-light scanning can effectively measure the 3D shape of an object, it suffers depth errors at object edges of the image and in long-range applications.

A time-of-flight (ToF) is another 3D scanning scheme that employs time-of-flight techniques to resolve distance between the system and the object for each point of the image, by measuring the round trip time of an artificial light signal provided by a light source such as laser or light-emitting diode. Contrary to the structured-light scanning, the time-of-flight scheme has limited capability in near-field applications.

A need has thus arisen to propose a novel scheme for overcoming limitations and disadvantages of conventional 3D scanning or sensing systems.

### SUMMARY

The present disclosure provides a hybrid three-dimensional (3D) sensing system including a time-of-flight (ToF) projector, a structured light (SL) projector, a ToF sensor, a ToF processor, and a SL processor. The ToF projector projects a modulated light on an object in a ToF mode. The SL projector projects a structured light on the object in a SL mode. The ToF sensor receives reflections from the object and correspondingly generates video data. The ToF processor receives the video data and generates ToF depth information according to the video data in the ToF mode. The SL processor receives a 2D image from the ToF processor and generates SL depth information according to the 2D image in the SL mode.

In accordance with one or more embodiments of the present disclosure, the hybrid 3D sensing system further includes a multiplexer. The multiplexer controls the ToF projector to project the modulated light in the ToF mode and controls the SL projector to project the structured light in the SL mode.

In accordance with one or more embodiments of the present disclosure, the ToF processor outputs a control signal to the multiplexer to control the multiplexer.

In accordance with one or more embodiments of the present disclosure, the SL processor receives the control signal from the ToF processer, such that the SL processor generates the SL depth information in the SL mode according to the control signal.

In accordance with one or more embodiments of the present disclosure, in the SL mode, the ToF processor receives the SL depth information from the SL processor and outputs the SL depth information to a backend device through a transmitting terminal of the ToF processor. The ToF processor outputs the ToF depth information to the backend device through the transmitting terminal in the ToF mode.

In accordance with one or more embodiments of the present disclosure, the ToF processor generates the 2D image according to the video data in the SL mode.

In accordance with one or more embodiments of the present disclosure, the modulated light is a flood light. The SL projector is a dot light source. The 2D image is a dot image.

The present disclosure further provides a hybrid 3D sensing system including a SL projector, a ToF sensor, a ToF processor, and a SL processor. The SL projector projects light on an object. The ToF sensor receives reflections from the object and correspondingly generates video data. The ToF processor receives the video data and generates ToF depth information according to the video data in a ToF mode. The SL processor receives a 2D image from the ToF processor and generates SL depth information according to the 2D image in a SL mode.

In accordance with one or more embodiments of the present disclosure, the SL processor receives a control signal from the ToF processer, such that the SL processor generates the SL depth information when the control signal corresponds to the SL mode.

In accordance with one or more embodiments of the present disclosure, in the SL mode, the ToF processor receives the SL depth information from the SL processor and outputs the SL depth information to a backend device through a transmitting terminal of the ToF processor. The ToF processor outputs the ToF depth information to the backend device through the transmitting terminal in the ToF mode.

In accordance with one or more embodiments of the present disclosure, the ToF processor generates the 2D image according to the video data in the SL mode.

In accordance with one or more embodiments of the present disclosure, the SL projector is a dot light source, wherein the 2D image is a dot image.

The present disclosure further provides a hybrid 3D sensing method. The hybrid 3D sensing method includes: projecting light on an object by a SL projector; utilizing a ToF sensor to receive reflections from the object and correspondingly generate video data; receiving the video data by a ToF processor, such that the ToF processor generates ToF depth information according to the video data in a ToF mode; and receiving a 2D image from the ToF processor and correspondingly generating SL depth information in a SL mode.

In accordance with one or more embodiments of the present disclosure, the hybrid 3D sensing method further includes: controlling a ToF projector to project a modulated light on the object in the ToF mode. The SL projector is controlled to project a structured light on the object in the SL mode.

In accordance with one or more embodiments of the present disclosure, the hybrid 3D sensing method further includes: outputting a control signal to a multiplexer by the ToF processor, such that the multiplexer controls the SL projector to project the structured light in the SL mode and controls the ToF projector to project the modulated light in the ToF mode.

In accordance with one or more embodiments of the present disclosure, the hybrid 3D sensing method further includes: receiving the control signal by a SL processor, such that the SL processor generates the SL depth information in the SL mode according to the control signal.

In accordance with one or more embodiments of the present disclosure, in the SL mode, the ToF processor receives the SL depth information and outputs the SL depth information to a backend device through a transmitting terminal of the ToF processor. The ToF processor outputs the ToF depth information to the backend device through the transmitting terminal in the ToF mode.

In accordance with one or more embodiments of the present disclosure, the ToF processor generates the 2D image according to the video data in the SL mode.

In accordance with one or more embodiments of the present disclosure, the SL projector is a dot light source, wherein the 2D image is a dot image.

In accordance with one or more embodiments of the present disclosure, the modulated light is a flood light.

In order to let above mention of the present disclosure and other objects, features, advantages, and embodiments of the present disclosure to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows a block diagram illustrating a hybrid 3D sensing system according to a first embodiment of the present disclosure.

FIG. 2 shows a flow chart of a3D sensing method corresponding to the hybrid 3D sensing system according to the first embodiment of the present disclosure.

FIG. 3 shows a timing chart for illustrating the 3D sensing method of FIG. 2 according to the first embodiment of the present disclosure.

FIG. 4 shows a block diagram illustrating a hybrid 3D sensing system according to a second embodiment of the present disclosure.

FIG. 5 shows a block diagram illustrating a hybrid 3D sensing system according to a third embodiment of the present disclosure.

FIG. 6 shows a flow chart of a 3D sensing method corresponding to the hybrid 3D sensing system according to the third embodiment of the present disclosure.

FIG. 7 shows a block diagram illustrating a hybrid 3D sensing system according to a fourth embodiment of the present disclosure.

### DETAILED DESCRIPTION

Specific embodiments of the present disclosure are further described in detail below with reference to the accompanying drawings, however, the embodiments described are not intended to limit the present disclosure and it is not intended for the description of operation to limit the order of implementation.

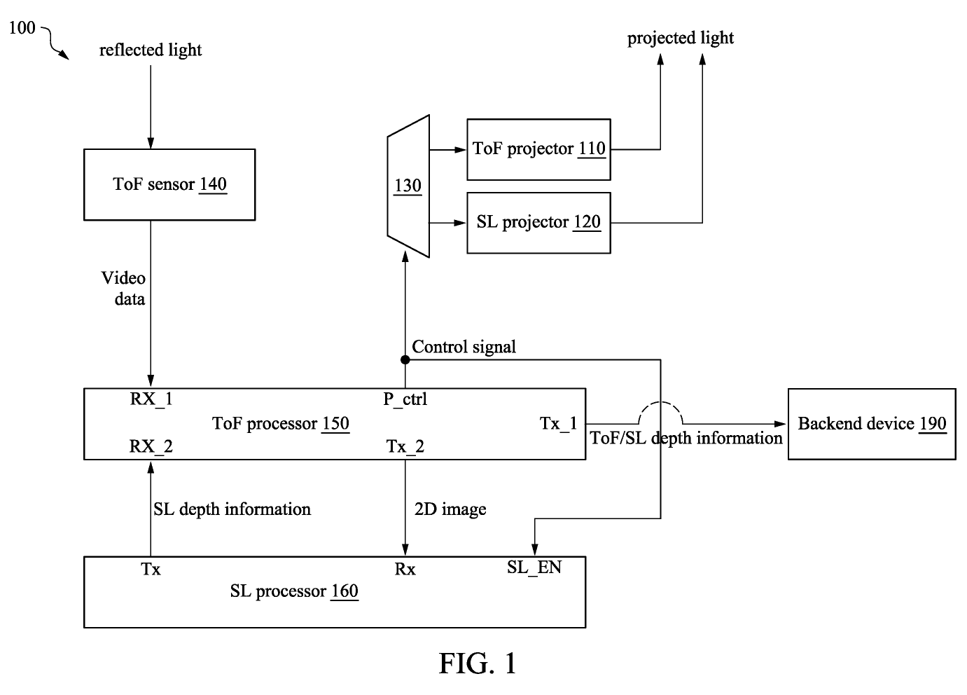

FIG. 1 shows a block diagram illustrating a hybrid three-dimensional (3D) sensing system 100 according to a first embodiment of the present disclosure. The hybrid 3D sensing system 100 includes a time-of-flight (ToF) projector 110, a structured light (SL) projector 120, a multiplexer 130, a ToF sensor 140, a ToF processor 150, and a SL processor 160. Each of the ToF processor 150 and the SL processor 160 may be implemented and executed by hardware (e.g., digital image processor), software or their combinations.

The ToF projector 110 is utilized to project a modulated light on an object (not shown in FIG. 1). Specifically, the ToF projector 110 is utilized to project a flood light (i.e., the modulated light is the flood light) suitable for TOF depth calculations. The ToF projector 110 may be a laser or LEDs.

The SL projector 120 is utilized to project a structured light in a particular pattern on the object. For example, the SL projector 120 is a dot light source to project plural dots (i.e., the structured light is in the form of a dot array) arranged to form a dot pattern on the object. The SL projector 120 may be a laser or LEDs.

The multiplexer 130 is utilized to control the ToF projector 110 to project the modulated light on the object in a ToF mode and control the SL projector 120 to project the structured light on the object in a SL mode.

The ToF sensor 140 is utilized to receive/capture reflections from the object and correspondingly generates video data. Specifically, the ToF sensor 140 adopts a ToF technique to resolve distance (or depth) between the ToF sensor 140 and the object for each point of a captured image, by measuring the round trip time of the emitted light. Specifically, the ToF sensor 140 is utilized to receive a reflected light from a surface of the object incident by the ToF projector 110 or the SL projector 120, thereby outputting the video data. The ToF sensor 140 may include a CMOS array, SPAD (Single-photon Avalanche Diode) detector, or any other sensor configured to detect reflections off of a target surface of the object.

A control terminal P_ctrl of the ToF processor 150 is coupled to the multiplexer 130, such that the ToF processor 150 outputs a control signal to the multiplexer 130 to control the multiplexer 130. Specifically, when the control signal corresponds to the ToF mode, the multiplexer 130 controls the ToF projector 110 to project the modulated light in the ToF mode. In contrast, when the control signal corresponds to the SL mode, the multiplexer 130 controls the SL projector 120 to project the structured light in the SL mode. In addition, the ToF processor 150 determines whether it is currently in the ToF mode or the SL mode according to the control signal.

A receiving terminal Rx_1 of the ToF processor 150 is coupled to the ToF sensor 140, such that the ToF processor 150 receives the video data from the ToF sensor 140. The ToF processor 150 generates ToF depth information according to the video data in the ToF mode. For example, the ToF depth information may be a ToF depth image (or depth map) containing ToF depth data of the pixels of the captured image. A transmitting terminal Tx_1 of the ToF processor 150 is coupled to a backend device 190, such that the ToF processor 150 transmits the ToF depth information to a backend device 190 in the ToF mode. Specifically, the ToF processor 150 outputs the ToF depth information to the backend device 190 through the transmitting terminal Tx_1 in the ToF mode.

The ToF processor 150 generates a 2D image (e.g., a dot image) according to the video data in the SL mode. Specifically, the ToF processor 150 demodulates the light reflections received at the ToF sensor 140 and correspondingly generates the 2D image containing intensity data of the pixels of the captured image. For example, the 2D image contains a dot pattern corresponding to the captured image. A transmitting terminal Tx_2 of the ToF processor 150 is coupled to the SL processor 160, such that the ToF processor 150 transmits the 2D image to the SL processor 160 in the SL mode.

The control terminal P_ctrl of the ToF processor 150 is further coupled to an enabled terminal SL_EN of the SL processor 160, such that the SL processor 160 receives the control signal and determines whether it is currently in the SL mode according to the control signal.

The SL processor 160 receives the 2D image from the ToF processor 150 and generates SL depth information according to the 2D image in the SL mode. Specifically, the SL processor 160 receives the control signal from the ToF processer 150, such that the SL processor 160 generates the SL depth information in the SL mode according to the control signal. For example, the SL depth information may be a structured light depth image (or depth map) containing structured light depth data of the pixels of the captured image. A transmitting terminal Tx of the SL processor 160 is coupled to a receiving terminal Rx_2 of the ToF processor 150, such that the ToF processor 150 transmits the SL depth information to the backend device 190 in the SL mode. Specifically, in the SL mode, the ToF processor 150 receives the SL depth information from the SL processor 160 and outputs the SL depth information to the backend device 190 through the transmitting terminal Tx_1.

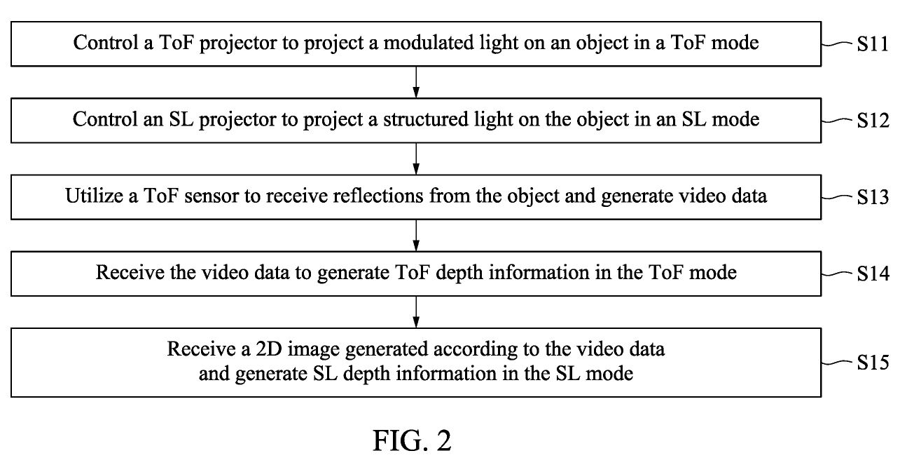

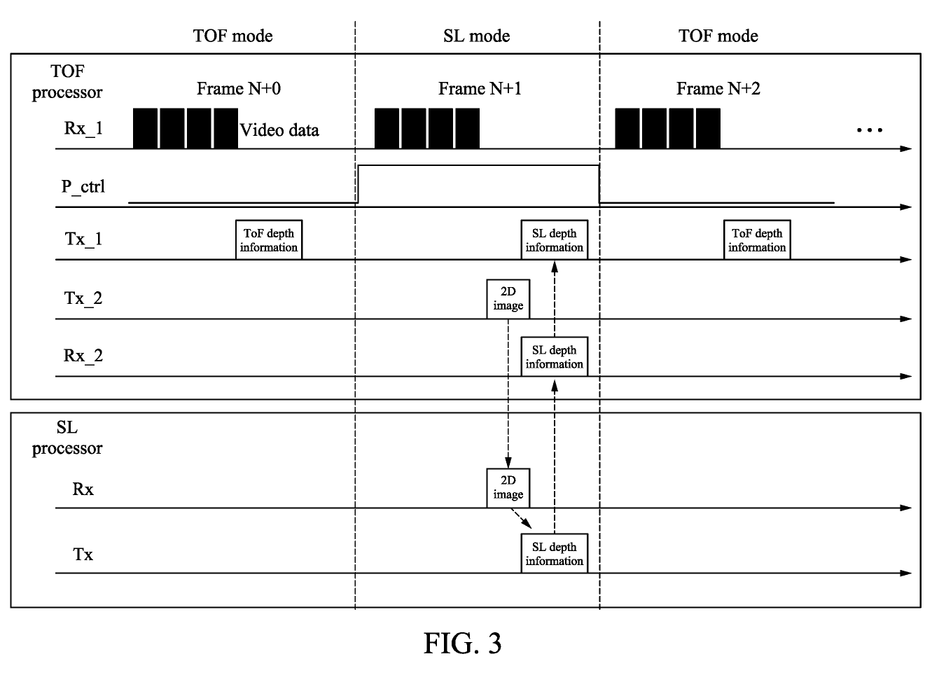

FIG. 2 shows a flow chart of a 3D sensing method corresponding to the hybrid 3D sensing system 100 according to the first embodiment of the present disclosure. FIG. 3 shows a timing chart for illustrating the 3D sensing method of FIG. 2 according to the first embodiment of the present disclosure.

In Step S11, the ToF projector 110 is controlled (by the multiplexer 130) to project the modulated light on the object in the ToF mode. In Step S12, the SL projector 120 is controlled (by the multiplexer 130) to project the structured light on the object in the SL mode. In Step S13, the ToF sensor 140 is utilized to receive reflections from the object and correspondingly generate the video data.

In Step S14, the video data is received by the ToF processor 150, such that the ToF processor 150 generates the ToF depth information according to the video data in the ToF mode. As shown in FIG. 3, in the ToF mode, the ToF processor 150 receives the video data through the receiving terminal Rx_1 of the ToF processor 150 and correspondingly outputs the ToF depth information to the backend device 190 through the transmitting terminal Tx_1 of the ToF processor 150.

In Step S15, the ToF processor 150 generates the 2D image according to the video data, and the SL processor 160 receives the 2D image from the ToF processor 150 and correspondingly generates the SL depth information in the SL mode. As shown in FIG. 3, in the SL mode, the ToF processor 150 receives the video data through the receiving terminal Rx_1 of the ToF processor 150 and correspondingly outputs the 2D image to the SL processor 160 through the transmitting terminal Tx_2 of the ToF processor 150, and then the SL processor 160 receives the 2D image through the receiving terminal Rx of the SL processor 160 and correspondingly outputs the SL depth information to the ToF processor 150 through the transmitting terminal Tx of the SL processor 160, and then the ToF processor 150 outputs the SL depth information to the backend device 190 through the transmitting terminal Tx_1 of the ToF processor 150.

The conventional hybrid 3D sensing system requires two projector (i.e., a ToF projector and a SL projector), two sensors (i.e., a ToF sensor and a SL sensor), and two processors (i.e., a ToF processor and a SL processor). In contrast, the hybrid 3D sensing system 100 of the present disclosure only requires two projector (i.e., the ToF projector 110 and the SL projector 120), one sensor (i.e., the ToF sensor 140), and two processors (i.e., the ToF processor 150 and the SL processor 160). Therefore, in comparison with the conventional hybrid 3D sensing system, the hybrid 3D sensing system 100 can reduce the manufacturing cost, the mechanism dimension, and the power consumption. In addition, the hybrid 3D sensing system 100 only includes one sensor, thereby avoiding the viewing angle difference (between two sensors), the correction process (for correcting characteristic difference between two sensors), and the signal interference which are caused by utilizing two sensors. Thus, the hybrid 3D sensing system 100 can reduce complexity of signal processing. Furthermore, a backend device of the conventional hybrid 3D sensing system requires two terminals to respectively receive the ToF depth information and the SL depth information, but the backend device 190 of the hybrid 3D sensing system 100 only requires one terminal (as shown in FIG. 1) to receive the ToF depth information and the SL depth information.

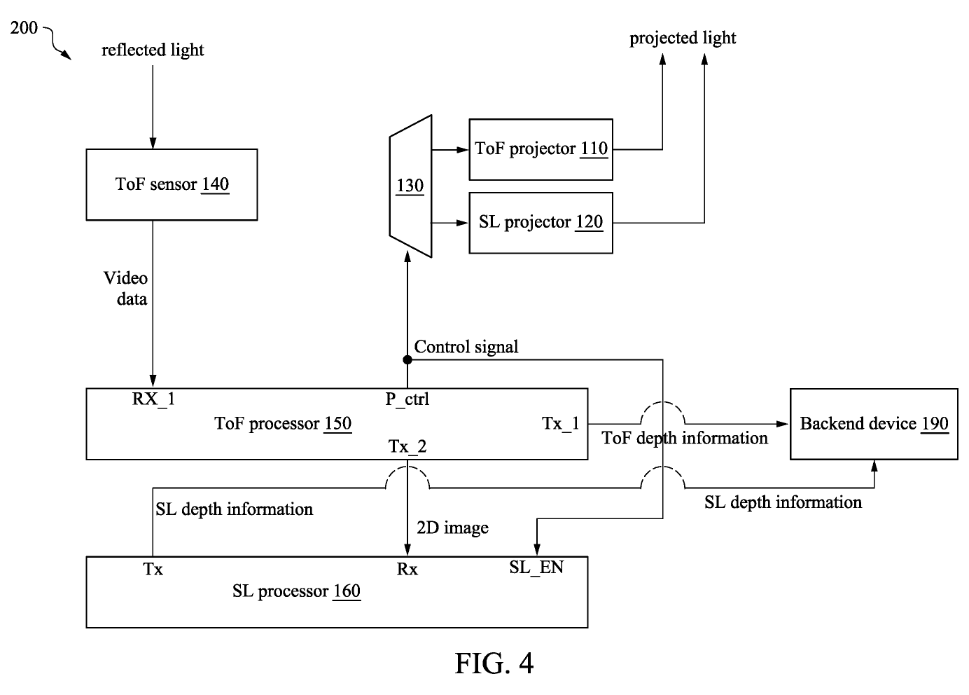

FIG. 4 shows a block diagram illustrating a hybrid 3D sensing system 200 according to a second embodiment of the present disclosure. The hybrid 3D sensing system 200 is similar to the hybrid 3D sensing system 100, except that the SL processor 160 directly outputs the SL depth information to the backend device 190 through the transmitting terminal Tx of the SL processor 160 in the SL mode.

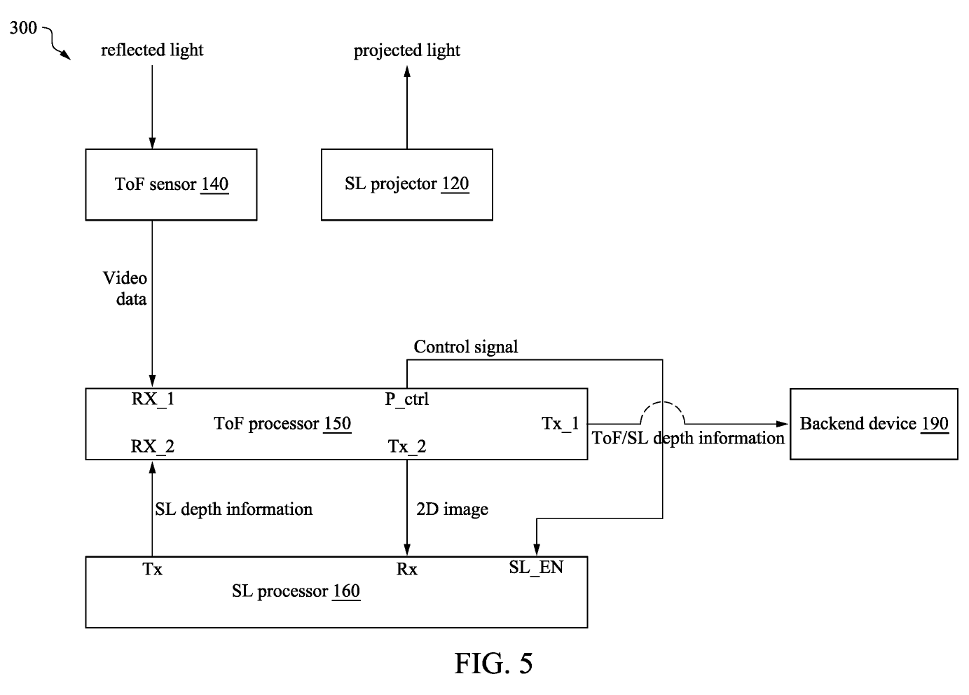

FIG. 5 shows a block diagram illustrating a hybrid 3D sensing system 300 according to a third embodiment of the present disclosure. The hybrid 3D sensing system 300 is similar to the hybrid 3D sensing system 100, except that the SL projector 120 is the only light source of the hybrid 3D sensing system 300. Therefore, the hybrid 3D sensing system 300 is not required to utilize the multiplexer to control two different light sources.

In comparison with the hybrid 3D sensing system 100, the hybrid 3D sensing system 300 only requires one projector (i.e., the SL projector 120), and therefore the hybrid 3D sensing system 300 can further reduce the manufacturing cost, the mechanism dimension, and the power consumption.

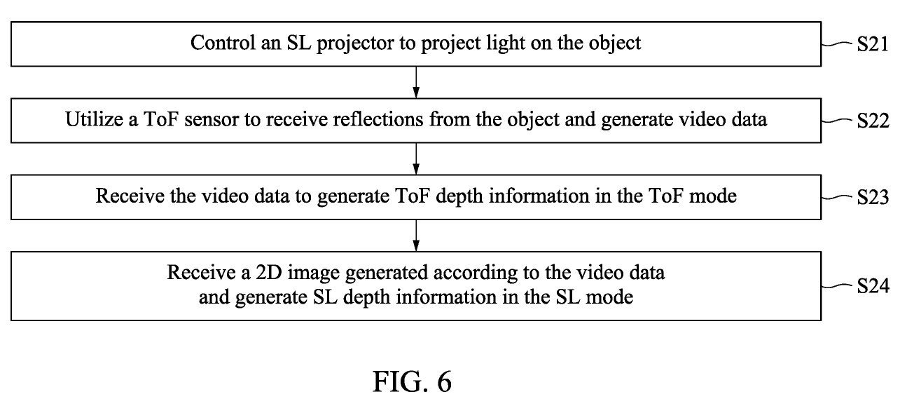

FIG. 6 shows a flow chart of a 3D sensing method corresponding to the hybrid 3D sensing system 300 according to the third embodiment of the present disclosure. In Step S21, the SL projector 120 (e.g., the dot light source) projects light (the structure light) on the object. In Step S22, the ToF sensor 140 is utilized to receive reflections from the object and correspondingly generate the video data.

In Step S23, the video data is received by the ToF processor 150, such that the ToF processor 150 generates the ToF depth information according to the video data in the ToF mode. In the ToF mode, the ToF processor 150 receives the video data through the receiving terminal Rx_1 of the ToF processor 150 and correspondingly outputs the ToF depth information to the backend device 190 through the transmitting terminal Tx_1 of the ToF processor 150.

In Step S24, the ToF processor 150 generates the 2D image according to the video data, and the SL processor 160 receives the 2D image from the ToF processor 150 and correspondingly generates the SL depth information in the SL mode. In the SL mode, the ToF processor 150 receives the video data through the receiving terminal Rx_1 of the ToF processor 150 and correspondingly outputs the 2D image to the SL processor 160 through the transmitting terminal Tx_2 of the ToF processor 150, and then the SL processor 160 receives the 2D image through the receiving terminal Rx of the SL processor 160 and correspondingly outputs the SL depth information to the ToF processor 150 through the transmitting terminal Tx of the SL processor 160, and then the ToF processor 150 outputs the SL depth information to the backend device 190 through the transmitting terminal Tx_1 of the ToF processor 150.

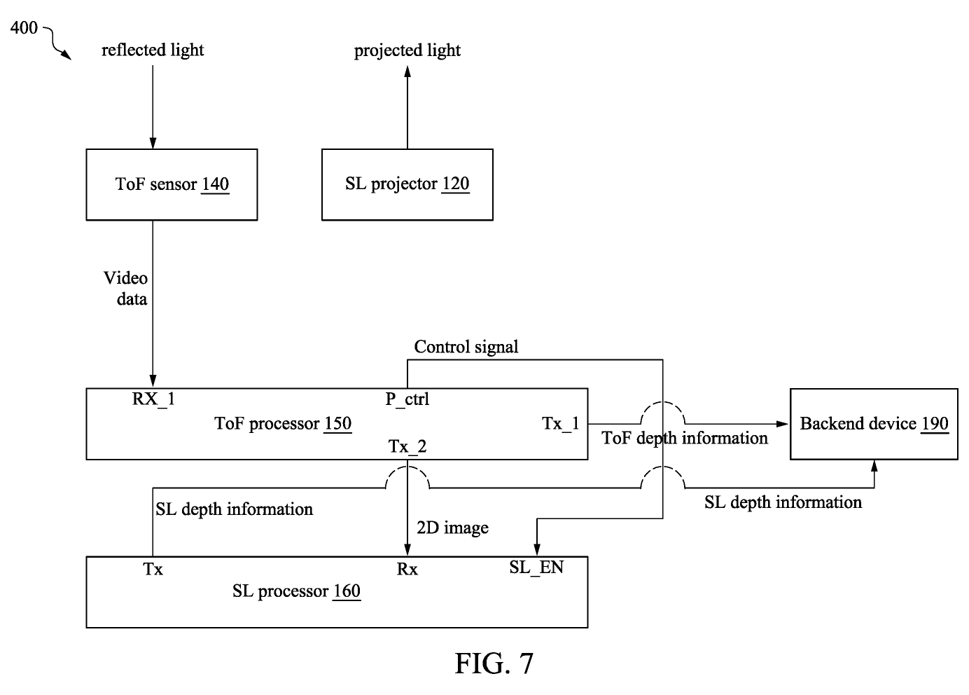

FIG. 7 shows a block diagram illustrating a hybrid 3D sensing system 400 according to a fourth embodiment of the present disclosure. The hybrid 3D sensing system 400 is similar to the hybrid 3D sensing system 300, except that the SL processor 160 directly outputs the SL depth information to the backend device 190 through the transmitting terminal Tx of the SL processor 160 in the SL mode.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A hybrid three-dimensional sensing system, comprising:
a time-of-flight (ToF) projector configured to project a modulated light on an object in a ToF mode;
a structured light (SL) projector configured to project a structured light on the object in a SL mode;
a ToF sensor configured to receive reflections from the object and correspondingly generate video data;
a ToF processor configured to receive the video data and generate ToF depth information according to the video data in the ToF mode; and
a SL processor configured to receive a 2D image from the ToF processor and generate SL depth information according to the 2D image in the SL mode.

2. The system of claim 1, further comprising:
a multiplexer configured to control the ToF projector to project the modulated light in the ToF mode and control the SL projector to project the structured light in the SL mode.

3. The system of claim 2, wherein the ToF processor outputs a control signal to the multiplexer to control the multiplexer.

4. The system of claim 3, wherein the SL processor receives the control signal from the ToF processer, such that the SL processor generates the SL depth information in the SL mode according to the control signal.

5. The system of claim 1, wherein in the SL mode, the ToF processor receives the SL depth information from the SL processor and outputs the SL depth information to a backend device through a transmitting terminal of the ToF processor, wherein the ToF processor outputs the ToF depth information to the backend device through the transmitting terminal in the ToF mode.

6. The system of claim 1, wherein the ToF processor generates the 2D image according to the video data in the SL mode.

7. The system of claim 1, wherein the modulated light is a flood light, wherein the SL projector is a dot light source, wherein the 2D image is a dot image.

8. A hybrid three-dimensional sensing system, comprising:
a SL projector configured to project light on an object;
a ToF sensor configured to receive reflections from the object and correspondingly generate video data;
a ToF processor configured to receive the video data and generate ToF depth information according to the video data in a ToF mode; and
a SL processor configured to receive a 2D image from the ToF processor and generate SL depth information according to the 2D image in a SL mode.

9. The system of claim 8, wherein the SL processor receives a control signal from the ToF processer, such that the SL processor generates the SL depth information when the control signal corresponds to the SL mode.

10. The system of claim 8, wherein in the SL mode, the ToF processor receives the SL depth information from the SL processor and outputs the SL depth information to a backend device through a transmitting terminal of the ToF processor, wherein the ToF processor outputs the ToF depth information to the backend device through the transmitting terminal in the ToF mode.

11. The system of claim 8, wherein the ToF processor generates the 2D image according to the video data in the SL mode.

12. The system of claim 8, wherein the SL projector is a dot light source, wherein the 2D image is a dot image.

13. A hybrid three-dimensional sensing method, comprising:
projecting light on an object by a SL projector;
utilizing a ToF sensor to receive reflections from the object and correspondingly generate video data;
receiving the video data by a ToF processor, such that the ToF processor generates ToF depth information according to the video data in a ToF mode; and
receiving a 2D image from the ToF processor and correspondingly generating SL depth information in a SL mode.

14. The method of claim 13, further comprising:
controlling a ToF projector to project a modulated light on the object in the ToF mode, wherein the SL projector is controlled to project a structured light on the object in the SL mode.

15. The method of claim 14, further comprising:
outputting a control signal to a multiplexer by the ToF processor, such that the multiplexer controls the SL projector to project the structured light in the SL mode and controls the ToF projector to project the modulated light in the ToF mode.

16. The method of claim 15, further comprising:
receiving the control signal by a SL processor, such that the SL processor generates the SL depth information in the SL mode according to the control signal.

17. The method of claim 13, wherein in the SL mode, the ToF processor receives the SL depth information and outputs the SL depth information to a backend device through a transmitting terminal of the ToF processor, wherein the ToF processor outputs the ToF depth information to the backend device through the transmitting terminal in the ToF mode.

18. The method of claim 13, wherein the ToF processor generates the2D image according to the video data in the SL mode.

19. The method of claim 13, wherein the SL projector is a dot light source, wherein the 2D image is a dot image.

20. The method of claim 14, wherein the modulated light is a flood light.
